(19) United States
(12) Patent Application Publication
(10) Pub. No.: US 2022/0399796 A1
(43) Pub. Date: Dec. 15, 2022

(54) DEVICE FOR ACTUATING A PHYSICAL OBJECT BY MAGNETICALLY DRIVEN FLUID FLOW

(71) Applicant: International Business Machines Corporation, Armonk, NY (US)

(72) Inventors: Sarbajit K. Rakshit, Kolkata (IN); Mukundan Sundararajan, Bangalore (IN)

(21) Appl. No.: 17/346,838

(22) Filed: Jun. 14, 2021

(51) Int. Cl. H02K 44/00; H01F 1/44

(52) U.S. Cl. CPC H02K 44/00; H01F 1/44

(57) ABSTRACT

Magnetic fluid partially fills a channel built into the main body an object (or mechanically attached to it). Magnetic fields are selectively applied in a controlled manner so that the magnetic fields actuate the magnetic fluid into motion and thereby actuates the main body into motion by applying a force to the channel which the magnetic fluid partially fills.

### BACKGROUND

The present invention relates generally to the field of propulsion of physical objects and also to the field of magnetic fluid systems.

The Wikipedia entry for “ferrofluid” (as of 20 May 2021) states, in part, as follows: “Ferrofluid is a liquid that is attracted to the poles of a magnet. It is a colloidal liquid made of nanoscale ferromagnetic, or ferrimagnetic, particles suspended in a carrier fluid (usually an organic solvent or water). Each magnetic particle is thoroughly coated with a surfactant to inhibit clumping. Large ferromagnetic particles can be ripped out of the homogeneous colloidal mixture, forming a separate clump of magnetic dust when exposed to strong magnetic fields. The magnetic attraction of tiny nanoparticles is weak enough that the surfactant's Van der Waals force is sufficient to prevent magnetic clumping or agglomeration. . . . In contrast to ferrofluids, magnetorheological fluids (MR fluids) are magnetic fluids with larger particles. That is, a ferrofluid contains primarily nanoparticles, while an MR fluid contains primarily micrometre-scale particles. The particles in a ferrofluid are suspended by Brownian motion and generally will not settle under normal conditions, while particles in an MR fluid are too heavy to be suspended by Brownian motion. Particles in an MR fluid will therefore settle over time because of the inherent density difference between the particles and their carrier fluid. As a result, ferrofluids and MR fluids have very different applications.” (footnotes omitted)

For purposes of this document, a “magnetic fluid” is hereby defined as any fluid that can be driven into motion (that is, actuated) by a magnetic field; “magnetic fluids” include ferrofluids, magnetorheological fluids, ferrifluids and any other types of magnetic fluid now known, or to be discovered in the future.

For purposes of this document, “mechanically connected” is defined as follows: Includes both direct mechanical connections, and indirect mechanical connections made through intermediate components; includes rigid mechanical connections as well as mechanical connection that allows for relative motion between the mechanically connected components; includes, but is not limited to, welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

### SUMMARY

According to an aspect of the present invention, a device includes: a main body; an elongated fluid conduit defined by a set of conduit surface(s) and having a first end and a second end; and magnetic fluid. The fluid conduit is mechanically connected to the main body. The magnetic fluid is located so that it partially fills and is enclosed by the fluid conduit. The fluid conduit, the main body and the magnetic fluid are sized, shaped, located and/or structured so that when a magnetic field is applied to the magnetic fluid, then the magnetic fluid will be actuated into motion away from the first end and toward the second end. The actuation of the magnetic fluid within the fluid conduit will actuate the main body into motion with respect to at least one degree of freedom/constraint.

According to an aspect of the present invention, a device includes: a main body; an elongated fluid conduit defined by a set of conduit surface(s) and having a first end and a second end; magnetic fluid; a set of magnet(s); and a computer sub-system. The fluid conduit is mechanically connected to the main body. The magnetic fluid is located so that it partially fills and is enclosed by the fluid conduit. The fluid conduit, the main body and the magnetic fluid are sized, shaped, located and/or structured so that when a magnetic field is applied to the magnetic fluid, then the magnetic fluid will be actuated into motion away from the first end and toward the second end. The actuation of the magnetic fluid within the fluid conduit will actuate the main body into motion with respect to at least one degree of freedom/constraint. The computer sub-system is programmed, connected, configured and/or structured to control the magnitude and/or directionality of magnetic fields that are selectively generated over time by the set of magnet(s).

According to an embodiment of present invention, a method includes the following operations (not necessarily in the following order): (i) providing a device including a main body, an elongated fluid conduit defined by a set of conduit surface(s) and having a first end and a second end, magnetic fluid, a set of magnet(s), and a computer sub-system, with: (a) the fluid conduit being mechanically connected to the main body, (b) the magnetic fluid being located so that it partially fills and is enclosed by the fluid conduit, (c) the fluid conduit, the main body and the magnetic fluid being sized, shaped, located and/or structured so that when a magnetic field is applied to the magnetic fluid, then the magnetic fluid will be actuated into motion away from the first end and toward the second end, and the actuation of the magnetic fluid within the fluid conduit will actuate the main body into motion with respect to at least one degree of freedom/constraint, and (d) the computer sub-system being programmed, connected, configured and/or structured to control the magnitude and/or directionality of magnetic fields that are selectively generated over time by the set of magnet(s); and (ii) using the computer sub-system to selectively power the set of magnet(s) to actuate the magnetic fluid into motion and thereby actuate the main body into motion.

### BRIEF DESCRIPTION OF THE DRAWINGS

FIG. 1A an orthographic, partially cross-sectional front view of a device according to a first embodiment of the present invention;

FIG. 1B a cross-sectional view of the first embodiment device;

FIG. 1C is an orthographic front view of the first embodiment device;

FIG. 2 is an orthographic front view of a device according to a second embodiment of the present invention;

FIG. 3 is an orthographic side view of a device according to a third embodiment of the present invention; and

FIG. 4 is an orthographic side view of a device according to a third embodiment of the present invention.

### DETAILED DESCRIPTION

Some problems that may be solved by some embodiments of the present invention will now be discussed in this paragraph. Some embodiments of the present invention are directed to a device a that includes: (i) a body including a conduit portion that includes conduit surface(s) defining an interior space (for example, the interior surfaces of a circular cross section pipe define a channel that guides fluid through the pipe); (ii) “magnetic fluid” (see definition, above, in the Background section) which partially fills the conduit; and (iii) a magnet sub-assembly that creates one, or more, magnetic fields that can be controlled at least in their intensity level.

The magnetic field(s) of the magnet sub-assembly are controlled in magnitude and/or polarity to actuate the magnet fluid in the conduit so that the magnetic fluid: (i) exerts a force on the body through the conduit surfaces of the conduit portion; and (ii) thereby actuates the body.

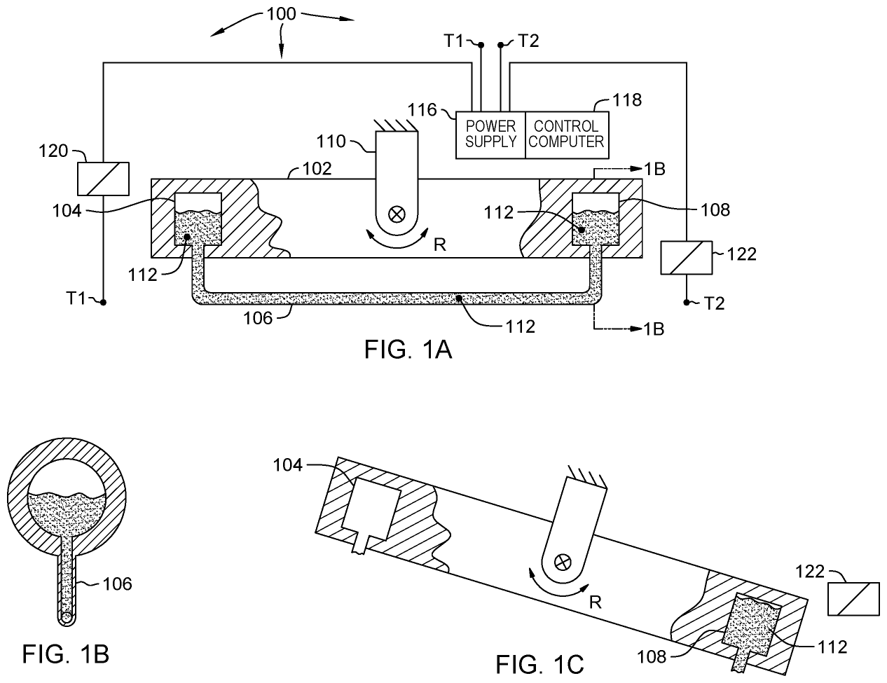

There may additionally be mechanical constraint sub-assemblies present. For example, a track is a constraint assembly that prevents a train from: (i) translating in any direction, except in a dimension defined by the direction of elongation of the track; and (ii) prevents the train from rotating about any axis (that is, no rotation about the axis parallel to the train's direction of motion, no rotation about the axis that runs traverse to the tracks and no rotation about the up/down vertical axis). Generally speaking, the various degrees of freedom/constraint inherent in the design of a given embodiment of the device will depend on the geometry of the body, the geometry of the conduit surfaces, and the positioning of the magnetic field(s) generated by the magnet sub-assembly. The various examples of FIGS. 1 to 4, discussed below, may help the reader understand how different degree(s) of freedom of motion, and corresponding degree(s) of constraint, can be achieved by a product designer.

Some embodiments of the present invention may include one, or more, of the following features, characteristics, advantages and/or operations: (i) magnetic fluid will partially be filled inside the hollow chamber of a 3D (three dimensional) printed object; (ii) creation of hollow chambers inside the 3D printed object and the filling of the magnetic fluid inside the 3D printed object will be part of the 3D printing procedure; (iii) the externally attached hollow chamber will be partially filled with magnetic fluid; (iv) while assembling the said 3D printed object or any other object, different angular alignment, or if a change in position is required, external magnetic force will be programmatically applied and controlled and will move the magnetic fluid inside the hollow chamber or externally mounted chamber; (v) the magnetic fluid will create a tilting motion that results in an angular alignment of the 3D printed object during assembly or material movement; (vi) the 3D printed object can effectively be moved, tilted with different angular fashion during assembly, or perform material movement; (vii) a fluid filled tape can be pasted across the pieces of a broken part or across the part that has to be removed so that these pieces can be turned and pulled out through a complex space; (viii) ferromagnetic particles can be dissolved in oil and used to make magnetic fluid, that is, there are various other magnetic fluids available (in this case the magnetic fluid will have properties of a fluid and also have magnetic properties); (ix) after the 3D object is printed, the said printed object is required for assembly and during assembly, the printed object can be rotated to align the printed object to the correct position; and/or (x) one potential application of the present invention involves the situation where some parts may have gotten stuck in the machinery and need to be removed without involving expensive dismantling of the machine.

Some embodiments of the present invention may include one, or more, of the following features, characteristics, advantages and/or operations: (i) while printing any 3D object, a computer program will analyze the required angular alignment of the object during assembly, handling and the like; (ii) a computer program will determine the geometry of the partially fluid filled hollow chamber created inside the main body of the 3D printed object; (iii) the computer program determines the type, volume and/or mass of the fluid that will be needed to partially fill the hollow chamber so that: (a) a programmatic external magnetic field can be used in order to effect the desired movement(s) of the magnetic fluid inside the hollow chambers to thereby create the desired movement(s); and/or (b) position the main body of the 3D printed object; (iv) the computer program analyzes the shape and dimensions of the object to be printed to calculate the center of gravity (CG) of the 3D printed object, and accordingly, decides how the CG has to be shifted to change the angular orientation of the object; and/or (v) the computer program calculates the required external magnetic force(s) and field(s) that need to be programmatically applied to effect the desired movement(s) and/or positioning.

Some embodiments of the present invention may include one, or more, of the following features, characteristics, advantages and/or operations: (i) in the assembly surrounding, an array of external magnetic fields will be applied, based on the position of the 3D printed object and the required angular orientation; (ii) a computer program dynamically controls the magnitude and/or polarity of the magnetic field(s); (iii) the magnetic fluid performs resultant movement, considering the gravity flow and magnetic force-based flow of the magnetic fluid; (iv) using a camera(s) or using ultrasound scanning, the required alignment will be identified; (v) a computer program calculates how the machined part is to be assembled and the required angular orientation of the 3D printed machine part; (v) the computer program generates a 3D model with the required hollow chamber; (vi) the 3D printer has the appropriate nozzle structure(s) to facilitate partially filling the hollow chamber with magnetic fluid; (vii) the magnetic fluid chamber can be attached separately, with any object is to be assembled or removed, so the required angular movement can be achieved with a externally attached partially filled magnetic fluid chamber; and/or (viii) some externally attachable fluid chambers, as mentioned above, may be constructed in the form of a tape.

Some embodiments of the present invention may include one, or more, of the following features, characteristics, advantages and/or operations: (i) a computer program identifies the degree and/or directionality of angular tilting required for: (a) material movement, and/or (b) assembling or removing the part from any robotic enabled picture capture or from its digital twin; (ii) the magnetic fluid chamber can be a part of the 3D printed object or can be an external accessory used for material movement of the part, or a piece of the part; (iii) the 3D printed object can have a hollow chamber or can also have an external detachable chamber; (iv) if the external chamber is attached with the 3D printed object, then the same will be attached with mechanical and/or a magnetic lock with the 3D printed object; (v) if the hollow chamber is created inside the 3D printed object, the hollow chamber will be partially filled with magnetic fluid; (vi) the magnetic fluid can flow through the hollow chamber, and accordingly, the CG of the object will be changed; (vii) based on the change in the CG, the object being moved will be tilted in an angular fashion; (viii) an external magnetic field will be applied around the material movement path, and accordingly, the magnetic field can be changed programmatically; (ix) based on the change in the magnetic field, the movement of the magnetic fluid will be controlled; (x) the movement of the magnetic fluid will change the CG of the object being assembled or being moved; and/or (xi) the magnetic fluid can be repositioned based on change in the magnetic field, and accordingly, the object can be tilted gradually.

As shown in FIGS. 1A to 1C, device 100 includes: main body 102; left side conduit end 104; intermediate conduit portion 106 (sometimes also herein referred to as pipe 106); right side conduit end 108; constraint sub-assembly 110 (sometimes also called rotational hardware 110 because it allows main body 102 to rotate in the direction of arrow R); magnetic fluid 112; power supply 116 (showing T1 (terminal 1) and T2 (terminal 2)); control computer 118; left side electromagnet 120; and right side electromagnet 122. When considered as a collective whole, left side electromagnet 120, right side electromagnet 122, power supply 116 and control computer 118 are called the “magnet sub-assembly.” When considered as a collective whole, left side conduit end 104, right side conduit end 108 and pipe 106 are called the “conduit portion.” In this example, the conduit potion is made up of: (i) interior spaces structured into main body 102 (that is, ends 104, 108); and (ii) interior space(s) defined into piece part(s) that are external to the main body, like pipe 106.

In operation, the magnet sub-assembly selectively generates one, or more, magnetic fields (not shown in the Figures). These magnetic fields can be adjusted over time and are, essentially, controlled by software running on the control computer (or a remote computer that is in data communication with the control computer). In this particular example, left side electromagnet 120 can be controlled, by power supply 116 and control computer 118, to fluctuate among and between three magnetic states over time: (i) no magnetic field state (the magnetic state of electromagnet 120 as it is shown in FIG. 1A); (ii) magnetic field of first polarity (the magnetic state of electromagnet 120 as it is shown in FIG. 1C); and (iii) magnetic field of second polarity (which is opposite the first polarity, in other words the magnetic poles are flipped). Electromagnet 122 can be controlled among the three states, similarly to the manner just explained in connection with electromagnet 120. Alternatively, the electromagnets may have different ranges and/or types of control capability—for example, there may be more granular control over the intensity of the magnetic field. As a further alternative, other types of magnets, types other than electromagnet, may be used, but the magnet must be susceptible to being controlled—at the very least, the magnet(s) must be susceptible to turning on and off (which, as those of skill in the art will appreciate, not all magnets are).

The magnetic fields interact with magnetic fluid 112 to drive fluid 112 into motion. As shown in FIG. 1A, the magnets are turned off and the magnetic fluid is balanced as between left side conduit end 104 and right side conduit end 108. As further shown in FIG. 1A, the interior spaces of conduit ends 104 and 108 are connected in fluid communication with each other through the interior space of pipe 106. The interior space of pipe 106 is best shown in FIG. 1B.

As shown in FIG. 1C, when the magnets are controlled to start generating magnetic fields, then the magnetic fluid is driven, by magnetic interaction, away from conduit end 104 and into conduit end 108. The forces exerted by the moving (that is, flowing) magnetic fluid on the interior surfaces of the conduit portion will cause main body 102 to rotate in the direction of double arrow R. In this embodiment, much of the force that the moving fluid exerts on the conduit surfaces is caused by gravity. More specifically, as the moving fluid flows from end 104 to end 108, this means that: (i) there is no longer gravitational force occasioned by a mass of magnetic fluid at conduit end 104; and (ii) there is additional gravitational force occasioned by a mass of magnetic fluid at conduit end 108 because additional magnetic fluid has been driven into conduit end 108 by the magnetic fields of the electromagnets. As further explained elsewhere in this document, the moving fluid causes a change in the center of gravity of main body 102. The change in center of gravity, taken in conjunction with the constraint provided by rotational hardware 110, causes a moment, in the plane of the page, about the pivot point of rotational hardware 110. This moment causes the tilting type displacement of main body 102 that can be observed by comparing the respective angular orientations of main body 102 as between FIG. 1A and FIG. 1C.

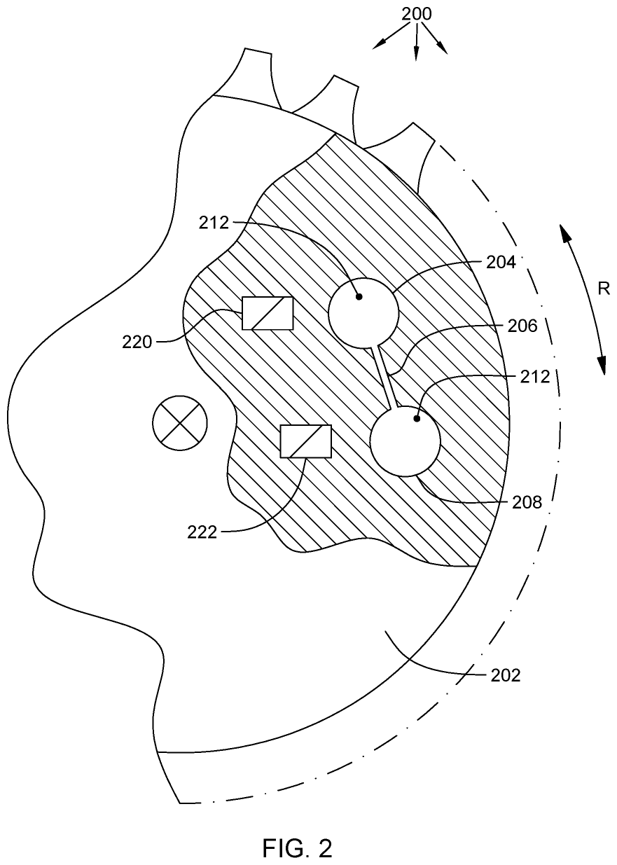

In this example of device 100, the degrees of freedom and constraint are as follows: (i) translation in X direction is prevented by rotational hardware 110; (ii) translation in Y direction is prevented by rotational hardware 110; (iii) translation in Z direction is prevented by rotational hardware 110; (iv) rotation about the X axis is prevented by rotational hardware 110; (v) rotation about the Y axis is prevented by rotational hardware 110; and (vi) rotation, within a certain angular range, about the Z axis (see the indication of the pivot points in FIGS. 1A and 1C) is permitted by rotational hardware 110. As will be shown, below, in connection with the embodiments of FIGS. 2 to 4, designs with other combinations of degrees of freedom/constraint are also possible.

As shown in FIG. 2, gear device 200 includes: gear body 202; first conduit portion 204; second conduit portion 206; third conduit portion 208; magnetic fluid 212; first electromagnet 220 and second electromagnet 222. As in the previous embodiment 100, the electromagnets are controlled (control computer not shown in FIG. 2) to create magnetic fields that move the magnetic fluid, which, in turn, exerts force on the walls of the conduit, which, in turn, causes the gear main body to rotate in the direction of double arrow R. As with device 100, various components, like gear body 202, can be manufactured by a 3D printer. This device also has but a single degree of freedom to move (that is, the gear body is free to rotate about the central axis of the gear body, but fully constrained with respect to the other five (5) degrees of freedom/constraint). Unlike device 100, gear device 200 is oriented to be horizontal (that is, the gear is generally parallel to the most proximate portion of the Earth's surface), meaning that this embodiment does not rely on gravitational forces, the way device 100 does. Also, unlike device 100, second conduit portion 206 is integrally built into the gear body and does not require separate fluid piping piece parts like pipe 106.

It is noted that electromagnets 220, 222 are embedded within the body of the gear itself, and are mechanically fixed to the gear body (with respect to all six (6) degrees of freedom/constraint). This is different than device 100, where the main body is movable, but the electromagnets are mechanically constrained to mechanical ground.2

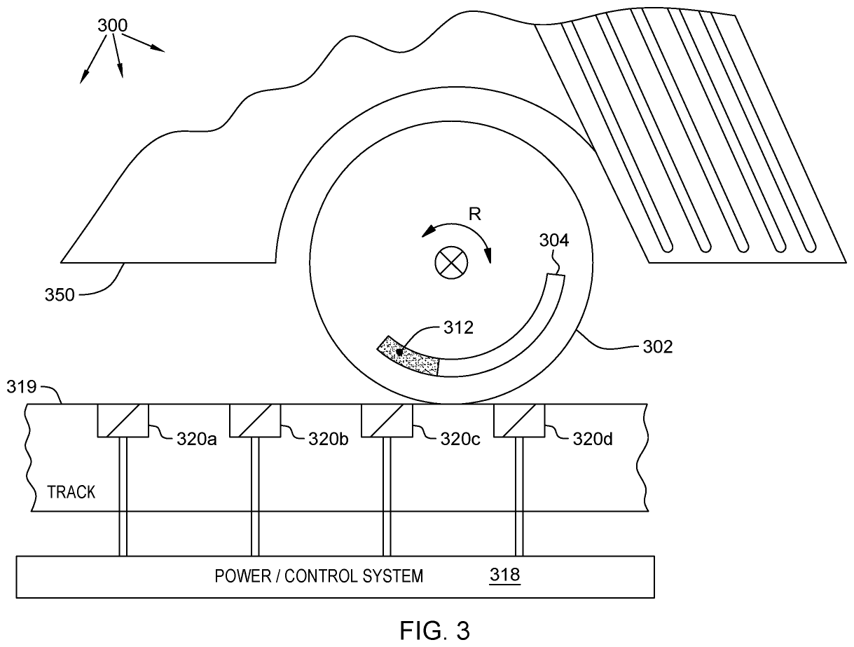

As shown in FIG. 3, train engine device 300 includes: wheel body 302; conduit portion 304; magnetic fluid 312; power/control computer system 318; train track 319; electromagnets 320a,b,c,d; and train engine body 350. Once again in this embodiment, the electromagnets are not mechanically fixed with respect to the body that they help move, but rather fixed to mechanical ground (more specifically, a train track). Alternatively, in other embodiments, the magnets may be mechanically fixed with respect to some other object that is not the body being moved, nor mechanical ground. This embodiment shows how devices according to the present invention may be “scaled up” by including many electromagnets and/or many conduits (for example, every wheel on the entire train could be fitted with similar wheels, and each wheel may include multiple conduits). As a final note on device 300, it is noted that the degrees of freedom/constraint are as follows: (i) free to translate in direction of X axis (that is, the direction of the train track); (ii) constrained from translating in direction of Y axis by gravity; (iii) constrained from translating in the direction of the Z axis (that is, constrained in the horizontal direction that is transverse to the track direction); (iv) free to rotate about the Z axis; (v) rotationally fixed with respect to rotation about the X axis; and (vi) rotationally fixed with respect to rotation about the Y axis.

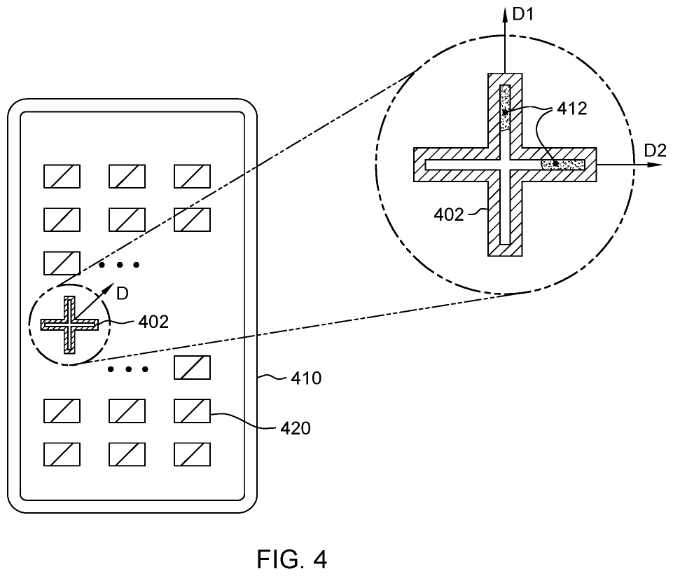

As shown in FIG. 4, planar transport device 400 includes: transport car main body 402; flat enclosure 410; magnetic fluid 412, and electromagnet 420. Enclosure 410 is a flat surface with a generally rectangular upstanding peripheral wall, as shown in FIG. 4. In this example, the magnetic fluid interactions can cause the transport car body to translate or spin, and the upstanding wall of flat enclosure 410 causes the transport car to be partially constrained in its motion, such that the car stays within the bounds of the enclosure. For example, if the magnetic fluid exerts force on the interior walls of the conduit in directions D1 and D2, then these forces will be added under vector addition, thereby resulting in a translation of the car in direction D.

The degrees of freedom/constraint are as follows: (i) free to translate in direction of X axis (that is, the left-right direction as device 400 is shown in FIG. 4); (ii) free to translate in direction of Y axis (that is, the up-down direction as one looks at FIG. 4); (iii) constrained from translating in the direction of the Z axis (that is, gravity keeps the transport car main body down on the flat surface of enclosure 412); (iv) free to rotate about the Z axis (that is, the transport body can spin as it remains down in contact with the flat surface of the enclosure); (v) rotationally fixed with respect to rotation about the X axis by gravity; and (vi) rotationally fixed with respect to rotation about the Y axis by gravity.

Some definitions will be set forth in the following paragraphs.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

What is claimed is:

1. A device comprising:
a main body;
an elongated fluid conduit defined by a set of conduit surface(s) and having a first end and a second end; and
magnetic fluid;
wherein:
the fluid conduit is mechanically connected to the main body;
the magnetic fluid is located so that it partially fills and is enclosed by the fluid conduit; and
the fluid conduit, the main body and the magnetic fluid are sized, shaped, located and/or structured so that when a magnetic field is applied to the magnetic fluid, then the magnetic fluid will be actuated into motion away from the first end and toward the second end, and the actuation of the magnetic fluid within the fluid conduit will actuate the main body into motion with respect to at least one degree of freedom/constraint.

2. The device of claim 1 wherein the fluid conduit is mechanically connected to the main body because the conduit surface(s) of the fluid conduit are structured and/or as surfaces of an interior space inside of the main body.

3. The device of claim 1 wherein the fluid conduit is mechanically connected to the main body because the fluid conduit is partially, but not wholly, structured and/or located as an interior space inside of the main body.

4. The device of claim 1 further comprising:
an exterior conduit member mechanically connected to the main body, with the exterior conduit member being mechanically connected to the main body, and with the exterior conduit member including a portion of the fluid conduit.

5. The device of claim 1 further comprising:
an exterior conduit member mechanically connected to the main body, with the exterior conduit member being mechanically connected to the main body, and with the exterior conduit member including an entirety of the fluid conduit.

6. The device of claim 1 wherein the magnetic fluid is at least partially made up of ferromagnetic fluid.

7. A device comprising:
a main body;
an elongated fluid conduit defined by a set of conduit surface(s) and having a first end and a second end;
magnetic fluid;
a set of magnet(s); and
a computer sub-system;
wherein:
the fluid conduit is mechanically connected to the main body;
the magnetic fluid is located so that it partially fills and is enclosed by the fluid conduit;
the fluid conduit, the main body and the magnetic fluid are sized, shaped, located and/or structured so that when a magnetic field is applied to the magnetic fluid, then the magnetic fluid will be actuated into motion away from the first end and toward the second end, and the actuation of the magnetic fluid within the fluid conduit will actuate the main body into motion with respect to at least one degree of freedom/constraint; and
the computer sub-system is programmed, connected, configured and/or structured to control the magnitude and/or directionality of magnetic fields that are selectively generated over time by the set of magnet(s).

8. The device of claim 1 wherein the computer sub-system is further programmed, connected, configured and/or structured to control the magnitude and/or directionality of magnetic fields that are selectively generated over time by the set of magnet(s) such that the magnetic field(s) of the set of magnet(s) directly actuate the magnetic fluid into motion and thereby indirectly actuate the main body into motion.

9. The device of claim 7 wherein the main body is actuated into rotational motion having a single degree of freedom/constraint.

10. The device of claim 7 wherein the main body is actuated into rotational motion about multiple axes.

11. The device of claim 7 wherein the main body is actuated into translational motion having a single degree of freedom/constraint.

12. The device of claim 7 wherein the main body is actuated into complex translational motion having at least two translational degrees of freedom of motion.

13. The device of claim 7 wherein the magnet(s) of the set of magnet(s) are electromagnet style magnets that are controlled with respect to the directionality and magnitude of their respective selective magnetic fields by selective application of electrical energy.

14. The device of claim 7 wherein the magnet(s) of the set of magnet(s) are mechanically connected with respect to the main body.

15. The device of claim 7 wherein the magnet(s) of the set of magnet(s) are not mechanically connected with respect to the main body.

16. A method comprising:
providing a device including a main body, an elongated fluid conduit defined by a set of conduit surface(s) and having a first end and a second end, magnetic fluid, a set of magnet(s), and a computer sub-system, with:
the fluid conduit being mechanically connected to the main body,
the magnetic fluid being located so that it partially fills and is enclosed by the fluid conduit,
the fluid conduit, the main body and the magnetic fluid being sized, shaped, located and/or structured so that when a magnetic field is applied to the magnetic fluid, then the magnetic fluid will be actuated into motion away from the first end and toward the second end, and the actuation of the magnetic fluid within the fluid conduit will actuate the main body into motion with respect to at least one degree of freedom/constraint, and
the computer sub-system being programmed, connected, configured and/or structured to control the magnitude and/or directionality of magnetic fields that are selectively generated over time by the set of magnet(s); and
using the computer sub-system to selectively power the set of magnet(s) to actuate the magnetic fluid into motion and thereby actuate the main body into motion.

17. The method of claim 16 wherein the computer sub-system includes a set of computer(s) and a set of power supply(ies).

18. The method of claim 16 wherein the use of the computer sub-system includes:
controlling, by machine logic, the timing and/or magnitude of electrical power supplied to the respective magnet(s) of the set of magnet(s); and
generating, by the magnet(s) of the set of magnet(s), magnetic fields that are located to do at least one of the following: (i) drive the magnetic fluid along the elongated fluid conduit in a direction away from at least one magnet of the set of magnet(s), and/or (ii) pull the magnetic fluid along the elongated fluid conduit in a direction toward at least one magnet of the set of magnet(s).
